(19) United States
(12) Patent Application Publication
(10) Pub. No.: US 2007/0044886 A1
(43) Pub. Date: Mar. 1, 2007

(54) Tire information tab protection device

(76) Inventor: Tsai Jen Lo, Changhwa Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/214,924

(22) Filed: Aug. 31, 2005

(51) Int. Cl. B60C 13/00

(52) U.S. Cl. 152/523; 152/524

(57) ABSTRACT

An information tab protection device for a tire includes at least one frame protruding from an outer surface of one of the sidewalls and an information tab is connected to the sidewalls having the at least one frame and is enclosed by the at least one frame.

### FIELD OF THE INVENTION

The present invention relates to a protection device protruding from sidewalls of a tire and enclosing an information tab on the sidewalls such that the information tab can be protected by the protection device.

### BACKGROUND OF THE INVENTION

A conventional tire is composed of a tread portion and sidewalls and the specification of the tire is integrally formed on the sidewalls so that the users can check the specification to choose proper tires they need. However, because the specification protrudes from the surface of the sidewalls so that it is easily worn out especially when the tires scrub curbs. Once the specification is worn out, the important information of the tire cannot be read by the users.

The present invention intends to provide a protection device which protrudes from the surface of the sidewalls and an information tab for the tire is enclosed by the protection device so that the information tab is protected by the protection device.

### SUMMARY OF THE INVENTION

The present invention relates to a tire which comprises a tread portion and sidewalls. At least one frame protrudes from an outer surface of one of the sidewalls and an information tab is connected to the sidewalls having the at least one frame and enclosed by the at least one frame. The information tab is protected by the at least one frame when the sidewall scrubs objects.

The present invention will become more obvious from the following description when taken in connection with the accompanying drawings which show, or purposes of illustration only, a preferred embodiment in accordance with the resent invention.

### BRIEF DESCRIPTION OF THE DRAWINGS

FIG. 1 is a side view to show a tire with a first embodiment of the protection device of the present invention;

FIG. 2 shows an information tab is connected to the sidewall of the tire and enclosed by the first embodiment of the protection device;

FIG. 3 is a side view to show a tire with a second embodiment of the protection device of the present invention;

FIG. 4 shows an information tab is connected to the sidewall of the tire and enclosed by the second embodiment of the protection device;

FIG. 5 shows an information tab is connected to the sidewall of the tire and enclosed by a third embodiment of the protection device;

FIG. 6 is a side view to show a tire with a fourth embodiment of the protection device of the present invention;

FIG. 7 shows an information tab is connected to the sidewall of the tire and enclosed by the fourth embodiment of the protection device;

FIG. 8 is a side view to show a tire with a fifth embodiment of the protection device of the present invention;

FIG. 9 shows an information tab is connected to the sidewall of the tire and enclosed by the fifth embodiment of the protection device, and

FIG. 10 shows an information tab is connected to the sidewall of the tire and enclosed by the sixth embodiment of the protection device.

### DETAILED DESCRIPTION OF THE PREFERRED EMBODIMENT

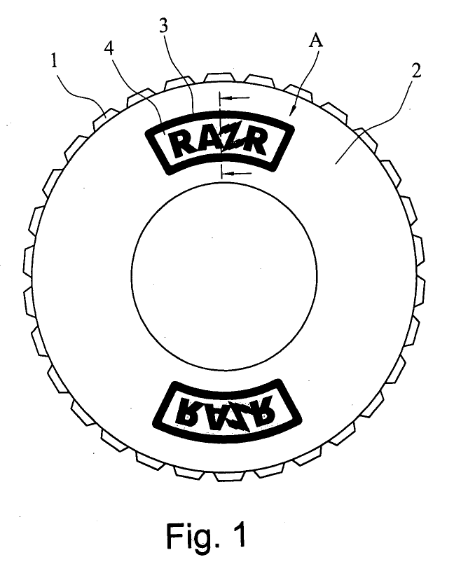

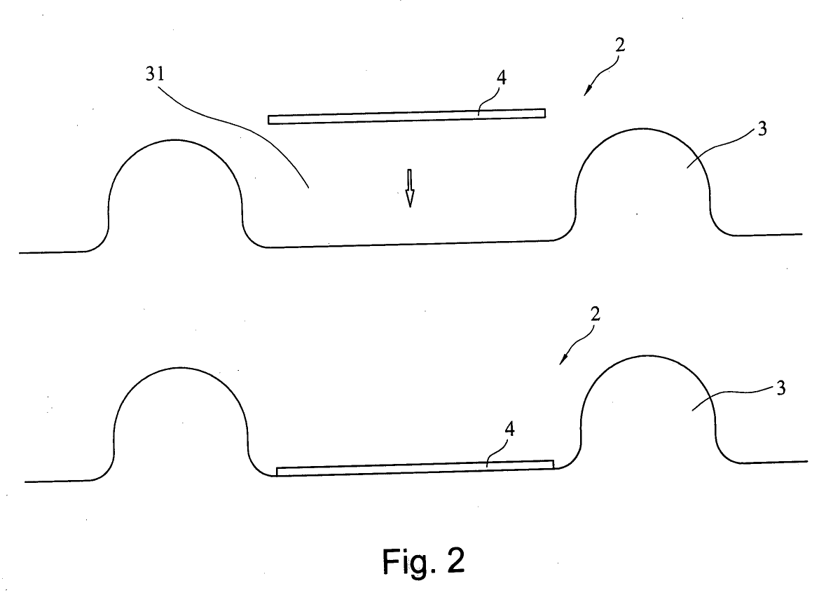

Referring to FIGS. 1 and 2, a tire includes a tread portion 1 and sidewalls 2, and the protection device “A” of the present invention includes two frames 3 protruding from an outer surface of one of the sidewalls 2 and two information tabs 4 are respectively connected to the sidewalls 2 at an area 31 enclosed by the frames 3. Each of the information tabs 4 is enclosed by the frame 3 and includes necessary information of the tire. A top surface of the information tab 4 is lower than the at least one frame 3. In the first embodiment, the frame 3 is composed of an enclosed continuous strip.

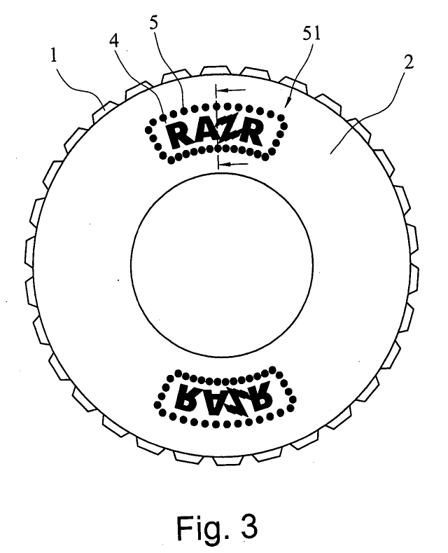

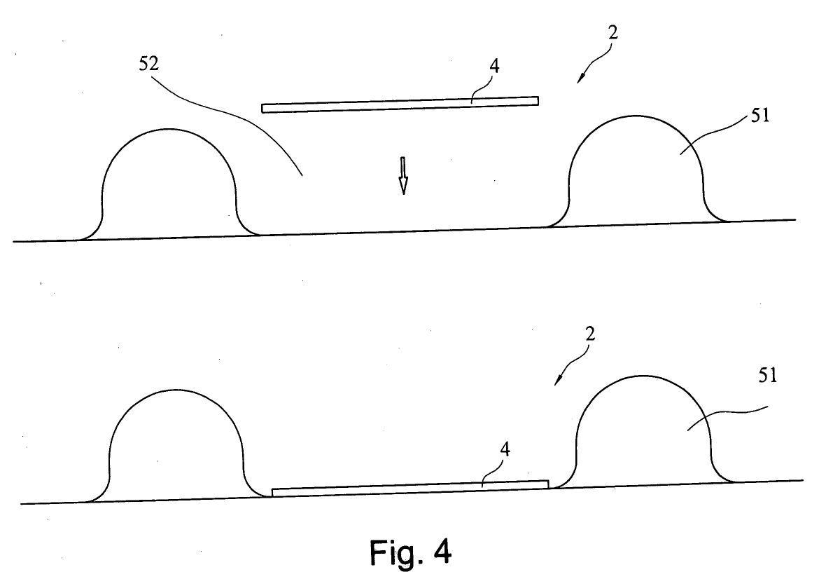

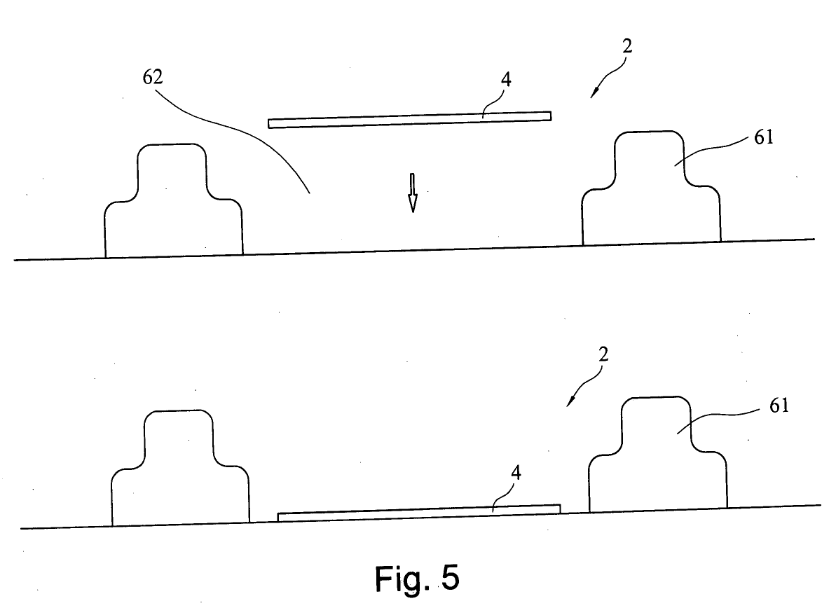

FIGS. 3 and 4 show a second embodiment of the protection device “A” wherein the frame 5 is composed of a plurality of bosses 51 which are semi-circular bosses. FIG. 5 shows a third embodiment of the protection device “A” wherein the frame is composed of a plurality of bosses 61 which wherein each boss 61 includes a wide base and a narrow top integrally connected on the wide base.

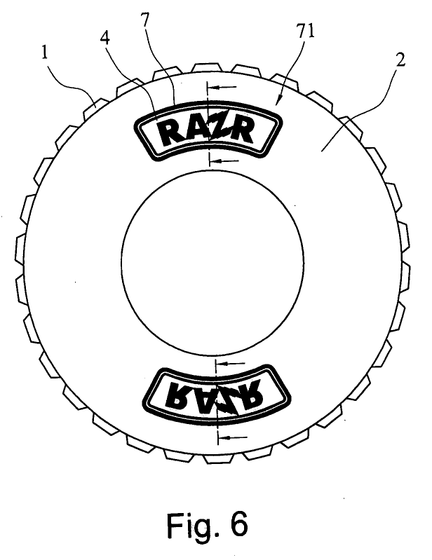

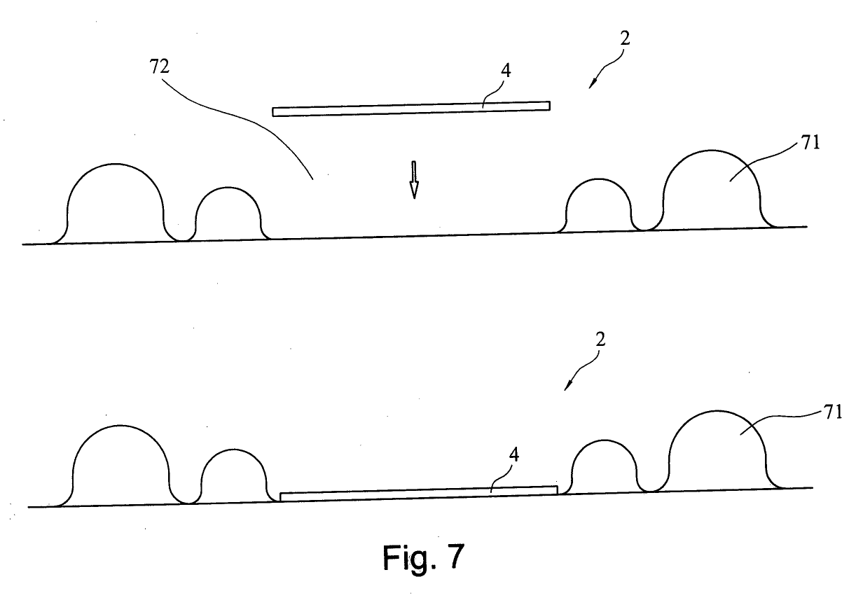

FIGS. 6 and 7 show a fourth embodiment of the protection device “A” wherein the frame 7 is composed of a plurality of bosses 71 which are arranged in an outer layer and an inner layer. The bosses 71 of the inner layer are smaller than the bosses 71 of the outer layer.

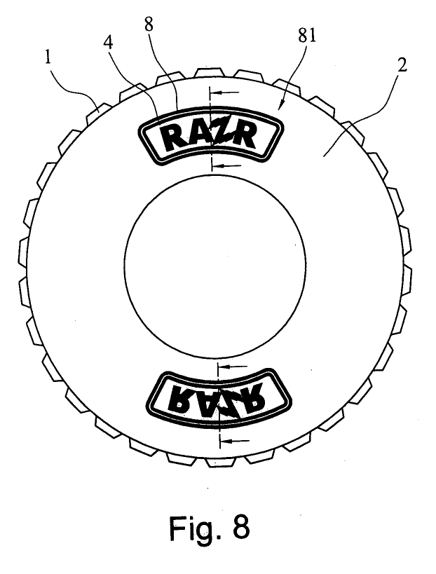

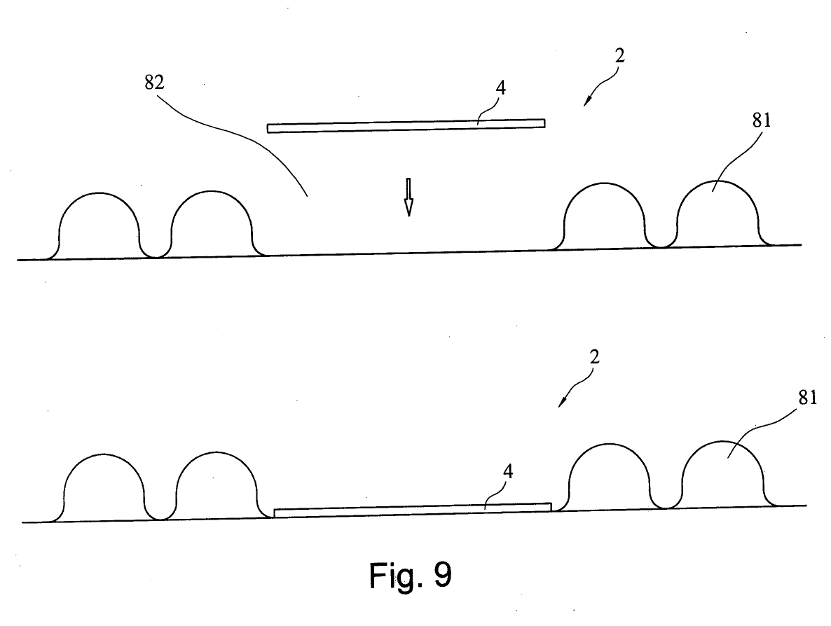

FIGS. 8 and 9 show a fifth embodiment of the protection device “A” wherein the frame 8 is composed of a plurality of bosses 81 which are arranged in an outer layer and an inner layer. The bosses 81 of the inner layer are the same size as the bosses 81 of the outer layer.

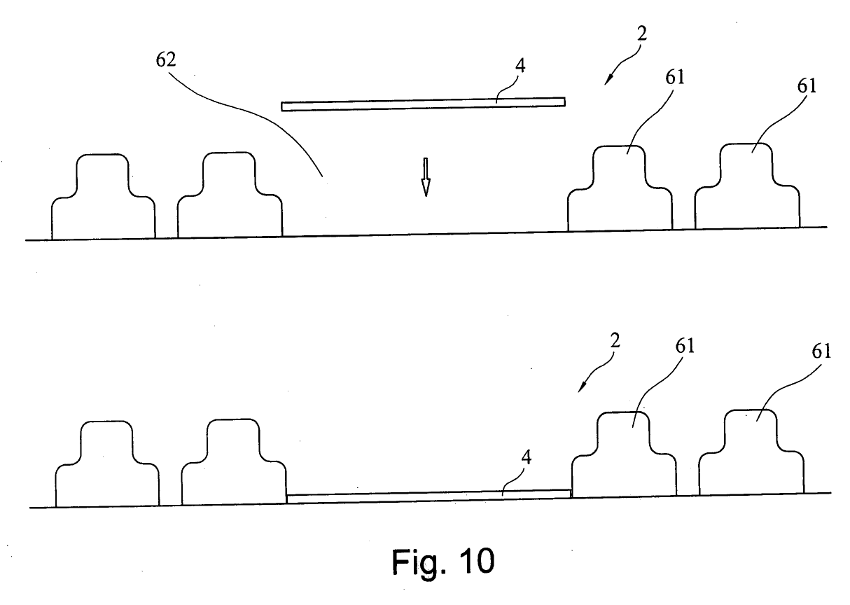

FIG. 10 shows a sixth embodiment wherein the frame is composed of a plurality of bosses 91 which are arranged in an outer layer and an inner layer. The bosses 91 of the inner layer are the same size as the bosses 91 of the outer layer. The bosses 91 of each of the inner layer and the outer layer include a wide base and a narrow top integrally connected on the wide base.

While we have shown and described the embodiment in accordance with the present invention, it should be clear to those skilled in the art that further embodiments may be made without departing from the scope of the present invention.

What is claimed is:

1. A tire comprising:
a tread portion and sidewalls, at least one frame protruding from an outer surface of one of the sidewalls and an information tab connected to the sidewalls having the at least one frame, the information tab being enclosed by the at least one frame.

2. The tire as claimed in claim 1, wherein the at least one frame is composed of an enclosed continuous strip.

3. The tire as claimed in claim 1, wherein the at least one frame is composed of a plurality of bosses.

4. The tire as claimed in claim 3, wherein each boss includes a wide base and a narrow top integrally connected on the wide base.

5. The tire as claimed in claim 1, wherein the at least one frame is composed of a plurality of bosses which are arranged in an outer layer and an inner layer.

6. The tire as claimed in claim 5, wherein the bosses of the inner layer are smaller than the bosses of the outer layer.

7. The tire as claimed in claim 5, wherein the bosses of the inner layer are the same size as the bosses of the outer layer.

8. The tire as claimed in claim 5, wherein the bosses of each of the inner layer and the outer layer include a wide base and a narrow top integrally connected on the wide base.

9. The tire as claimed in claim 1, wherein a top surface of the information tab is lower than the at least one frame.
